(19) United States
(12) Patent Application Publication
(10) Pub. No.: US 2019/0244255 A1
(43) Pub. Date: Aug. 8, 2019

(54) METHODS FOR DELIVERING CONTENT USING AN ON-DEMAND ACCESS PLATFORM

(71) Applicant: Jeffrey Ronald COHEN, Washington, DC (US)

(72) Inventor: Jeffrey Ronald COHEN, Washington, DC (US)

(21) Appl. No.: 16/266,298

(22) Filed: Feb. 4, 2019

Related U.S. Application Data
(60) Provisional application No. 62/625,522, filed on Feb. 2, 2018.

(51) Int. Cl. G06Q 30/02

(52) U.S. Cl. CPC G06Q 30/0275

(57) ABSTRACT

A system includes a platform that allows consumers to access content from a content provider as desired. The consumer pays a transaction fee to access the content, and is not tied to any subscription based service. The consumer may receive the content directly from the content provider. Advertisers can bid upon access to deliver content to users. The advertisers bid to underwrite delivery of the content. The platform also allows advertisers to purchase additional delivery of the content using real-time data from the platform. Real-time information is provided to content providers and other entities as the content is accessed.

### FIELD OF THE INVENTION

The present invention relates to delivering content to user using a platform that engages real-time with the campaign to determine whether to engage financially to deliver the content to users. An entity may bid on the ability to fund or otherwise utilize an advertisement-based platform for delivering the content.

### DESCRIPTION OF THE RELATED ART

In today's market, content delivery is of increasing importance. Consumers have embraced the “on-demand” platform of content delivery for music, movies, games, social media, messaging, and the like. Content providers, however, seek avenues to increase their revenue streams so that they can continue to create works as well as benefit from their efforts. Unfortunately, the monetization of their content may prohibit them from reaching markets that cannot afford to purchase the content to develop new consumers and fans. Another aspect of content delivery is early or private access to the content. For example, some consumers may be interested in purchasing access to a song prior to its release to the public. Again, this action may require resources not available to everyone.

The current model of content delivery usually involves subscription-based services. A consumer pays a fee every month, quarter, year, and the like to obtain access to the content. The consumer compensates the subscription service the same amount no matter how much content is delivered. For example, the consumer pays a monthly fee to access musical content available on the platform. Limitations of subscription services include paying the same fee no matter how much the platform is used, available content is limited to what the service provides, and content providers are forced to negotiate with the service to provide content to their potential customers. Content providers cannot provide their content directly to the consumer. Cancellation of subscription services also can be a hassle. Many consumers merely forget or do not make the effort to cancel services that they do not need or want.

Another model is one of providing access to the content for free, but this type of model involves harassing the consumer with advertisements, multiple page loads for little to no content, or registering with a service only to receive numerous emails, texts, and the like that annoy the consumer. Further, the consumer usually must register using information that should remain private, such as an email address, mobile phone number, and the like. For content providers, this model limits their revenue stream as it may be dependent on how many advertisements are sold or used or “followers” for their content.

### SUMMARY OF THE INVENTION

A method for providing content to a consumer over a network is disclosed. The method includes receiving payment from the consumer or an entity at a content delivery platform. The method also includes identifying the payment for content created by a content provider. The method also includes accessing the content at a location within the network accessible by the content delivery platform. The method also includes delivering the content to a device connected to the network.

A method for delivering content to a plurality of consumers over a network also is disclosed. The method includes receiving payment for delivery of the content over the network at a content delivery platform. The payment is provided by an entity. The method also includes providing the content from a content provider to the plurality of consumers over the network using the content delivery platform. The method also includes tracking in real-time the amount of payment left after at least one delivery of the content. The method also includes determining when the payment is depleted or a limit for delivery of the content has been reached. The method also includes stopping delivery of the content over the network using the content delivery platform.

A method for bidding to provide content over a network to a plurality of consumers also is disclosed. The method includes indicating content to be made available over the network through a content delivery platform. The method also includes receiving at least one bid to make the content available over the network via payment to a content provider of the content. The method also includes determining one or more bids to accept payment from at least one entity to provide the content at the content delivery platform. The method also includes delivering the content to the plurality of consumers according the payment or payments received corresponding to the one or more bids.

The disclosed embodiments also allow a company interested in promoting its products, brand, and the like to intercede in content delivery such that additional consumers are reached with the content that otherwise may not gain access as well as compensate the content providers. In other words, a company, or advertiser, may underwrite or purchase the ability to contribute in the act of content delivery to the consumers. Thus, the content may be made available to consumers and markets that otherwise would not have access in the early release process. In return, the company may promote its brand and products to these consumers.

In some embodiments, the disclosed processes and platform allows the company providing access to consumers to the delivered content to monitor in real-time the effectiveness of the campaign and whether it would like to purchase additional ability to underwrite the content delivery. Thus, the disclosed embodiments aggregate large amounts of disparate data and information to provide to the company or companies seeking to purchase the ability to promote the delivery of the content.

### BRIEF DESCRIPTION OF THE DRAWINGS

Various other features and attendant advantages of the present invention will be more fully appreciated as the same becomes better understood when considered in conjunction with the accompanying drawings.

FIG. 1 illustrates a client-server environment for a content delivery system according to the disclosed embodiments.

FIG. 2 illustrates a block diagram a computer system for use in executing the processes according to the disclosed embodiments.

FIG. 3 illustrates a flow diagram for a process to provide content to a user according to the disclosed embodiments.

FIG. 4 illustrates a flow diagram of a process for providing content using a platform within the content delivery system according to the disclosed embodiments.

FIG. 5 illustrates a flow diagram for a process to further underwrite content delivery of an existing advertisement campaign according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims. Numerous specific details are set forth in order to provide a thorough understanding of the present invention.

Limitations of current content delivery models are noted above. Future consumers will turn away from subscription based platforms or those with emphasis on heavy advertisements and registrations. Younger consumers, for example, do not want to pay for content that they do not want or access. Further, as consumers move to more mobile platforms, they do not want to be tied to a service only available at home or on specific devices. Subscription services also reward frequent users that access content on a regular basis and penalize those consumers that only access the platform on an intermittent basis. For example, a user that accesses the platform once a month pays a far larger amount for the service than someone who accesses it daily. In effect, the intermittent or rare consumer subsidizes the content access of one that uses the service frequently.

Not every potential customer can afford to subscribe to services or has access to networks for such services. This has an impact on a global scale. A content provider may be limited to reaching only affluent audiences or those in highly developed locations. A consumer, however, may be willing to purchase content from a specific content provider on demand but not wanting to subscribe for content that is not of interest. The disclosed embodiments solve this problem plus those inherent with subscriber or advertisement based services by providing a platform that allows a consumer to purchase access to only the content he or she wants. Further, the consumer may make small, or micro, transactions to access the content that goes to the content provider. This feature is especially desirable for those consumers and content providers seeking to use cryptocurrency, such as Bitcoin, to receive compensation.

Another feature of the disclosed embodiments is the ability for an entity to underwrite access to the content. The content is available through the platform for a set amount of money, downloads, or other metric due to the underwriting by the entity. Once the amount has been spent or reached, the content is only available through direct purchase by the consumer. A unique aspect of the disclosed embodiments is the ability of the bidder to monitor in real-time the underwriting campaign to determine effectiveness, market reach, demographics, and other information so as to determine whether to continue underwriting the access. A bidding process also may be implemented such that content providers can select the best business relationship to pursue for allowing access to their content, as opposed to subscription services.

Content providers also may access the disclosed platform to determine effectiveness of the delivery of their content to consumers. Metrics may be developed and monitored such that a content provider can determine demographics, marketing strategies, and other information to help in reaching a maximum amount of consumers. For example, as a campaign is in operation, a content provider may determine what locations are accessing the content, the age or other information about the users, and identify whether any underwriter or advertiser is resonating with the audience so as to determine future collaboration opportunities with those companies.

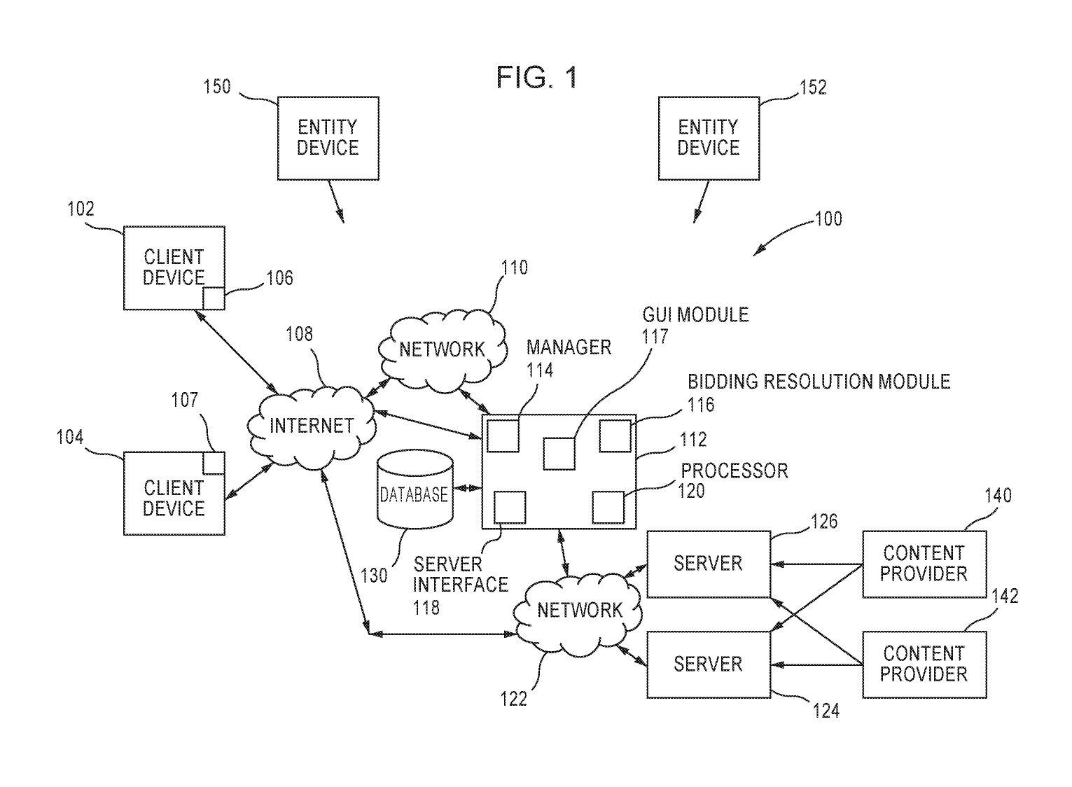

FIG. 1 illustrates a client-server environment for a content delivery system having an advertisement-based platform 112 according to the disclosed embodiments. A client-server wide area network system 100 is shown. System 100 includes client devices 102 and 104 that host or execute applications for browsers 106 and 107, respectively. Clients devices 102 and 104, via a wide area network such as Internet 108, can achieve a connection to other networks such as network 110 and to servers and platforms, such as platform 112. In some embodiments, client devices 102 and 104 may be mobile devices, such as a smart phone or tablet. Alternatively, client devices 102 and 104 may be computers or laptops. Client devices 102 and 104 are used to access content within system 100.

Content delivery platform 112 facilitates the delivery of content from associated locations to users while accepting bids from entities to deliver the content. Platform 112 connects to database 130 and to other networks such as network 122. Platform 112 can include a content delivery manager 114, a bidding resolution module 116, a GUI module 117, a server interface 118, and a content delivery processor 120. Network 122 may connect to a content server 126, and a content server 124 such that many different types of content with a variety of formats may be provided to a client device via selectable links having network addresses. Content may be provided to servers by content providers 140 and 142. As appreciated, any number of content providers may provide content within system 100. Moreover, system 100 may include any number of servers connected through networks that are accessible by platform 112 to retrieve information and provide content.

Browsers 106 and 107 can facilitate user-browser interactions to communicate between client devices 102 and 104, platform 112, and associated servers. For example, browser 106 may be enabled with computer executable code or other code that enables transmission of interaction details from client device 102 to platform 112 and servers 124 and 126. These codes may include programming codes that can be embedded in Hypertext Markup Language (HTML) or other language of a page to provide additional functionality and is generally supported by browser 106.

When a user utilizing client device 102, such as a computer, tablet, smartphone and the like, wants to view a webpage or address having downloads, streaming content, and the like, browser 106 transmits a network address of a webpage. Specifically, browser 106 may transmit information about the desired content stored within database 130 to platform 112. In turn, browser 106 displays or makes available the requested information to the user.

Content stored in database 130 or in servers 126 or 124 may be located via selectable links displayed with the collection of websites. The user can click on the links to view the content provided by the servers but in a frame environment, disclosed in greater detail below. Request processor 120 may handle these requests as needed. This content, however, may not be accessible absent permission provided by platform 112.

In some embodiments, users of the client devices want to access the content available through system 100. Unlike a subscription or advertisement based model, a user may access platform 112 to obtain the content directly and on-demand. Platform 112 obtains payment from the user and allows access to the content. For example, using network 110, content provider 140 uses platform 112 to obtain transactions for access to its content stored on server 126 (or elsewhere). Content provider 140 is compensated directly after a percentage provided to the administrators of platform 112.

Because of the direct nature of platform 112, a user may access the content whenever desired. Platform 112 tracks the use of the content in that once it is played or viewed, then access to the content is denied. Network 110 goes to platform 112 so that the user may not circumvent payment for access to the content. When content provider 140 wants to provide access to the content for free, such as after an initial trial period, access to its servers and content may be routed through network 122 to avoid platform 112. As noted above, consumers want early access to content for content providers. Whether it is a new song, movie, video, graphic, game, or other downloadable item, a consumer will pay to get access before the general public. The early access allows the consumer to be part of the initial buzz or ratings for the content as well as being a presence on social media.

Another feature of the disclosed embodiments is the availability of metrics for the content providers. A subscription based service does not allow a content provider to know who is exactly looking at the content. At most, an address or billing location may be available and some demographics about people at that location. Further, as noted above, only affluent locations or households may have access to such services. Platform 112 is able to track who, where, and how the content is accessed. It also may track whether the content is accessed for the entire file or only partially. For example, consumers may be dropping off listening to a song after a minute. Platform 112 also may track repeat consumers as well as provide real-time metrics for the content providers.

Thus, the disclosed embodiments provide platform 112 to allow access to content from content providers on a paid basis. Users pay a transaction fee to access the content directly and on-demand. Users do not need to register for a subscription or repeat charges for access. Content providers may engage directly with their customers and charge what they believe is reasonable for access. Content providers also may tailor campaigns to their customers, such as releasing exclusive content for a limited period, without having to negotiate with subscription service providers or placing it on advertisement based platforms, which annoy consumers.

In certain instances, client devices 102 and 104 are allowed to access content over system 100 using platform 112 before release to the general public. This access is provided by paying a fee or use of crypto-currency by a user. As can be appreciated, not every user can afford such a fee, which is used to compensate the content providers for their works. In order to allow users access to the content, one or more entities may compensate the content providers using platform 112 to allow access to the content over system 100. Manager 114 may determine that such access is allowed for a certain period of time based on the compensation provided by the one or more entities. After this period is complete, a user will need to pay to access the content.

In return for the compensation, an entity may promote its goods or services using platform 112. For example, an entity using entity device 150 pays a compensation fee to allow access for users to content provided by a popular music artist. The content includes a song and video stored servers 126 and 124. A user with client device 102 logs onto network 110 to use platform 112 to access the content. It sends instructions to platform 112 to provide the information needed to access the content.

Platform 112 determines if client device 102 is allowed to access the content by either paying the fee or if within the period secured by the entity using entity device 150. An “entity” may include a corporation, individual, group, and the like. If not, then client device 150 is not allowed access to the content. When the song and video are available to the general public, client device 102 may access network 122 to obtain the content without the use of platform 112. Yet, at least for this period before the general release, users are routed through platform 112 for accessing the content.

Entity device 150 may monitor and receive real-time feedback on the progress of downloads or streaming of the content as well using platform 122. GUI module 117 interacts with entity device 150, as well as other entity devices of interested entities, to provide this real-time information. This results in objective and informative data for the entities to make decisions whether to continue funding the period for platform 112 to remain active or possibly withdraw.

In some embodiments, different entities “bid” to provide the content to user over platform 112. Bidding resolution module 116 receives bids or payments to provide content over platform 112. Bidding resolution module 116 also acts in real-time to ensure content delivery is not interrupted or delayed due to unavailability of compensation for the content providers. These embodiments are disclosed in greater detail below.

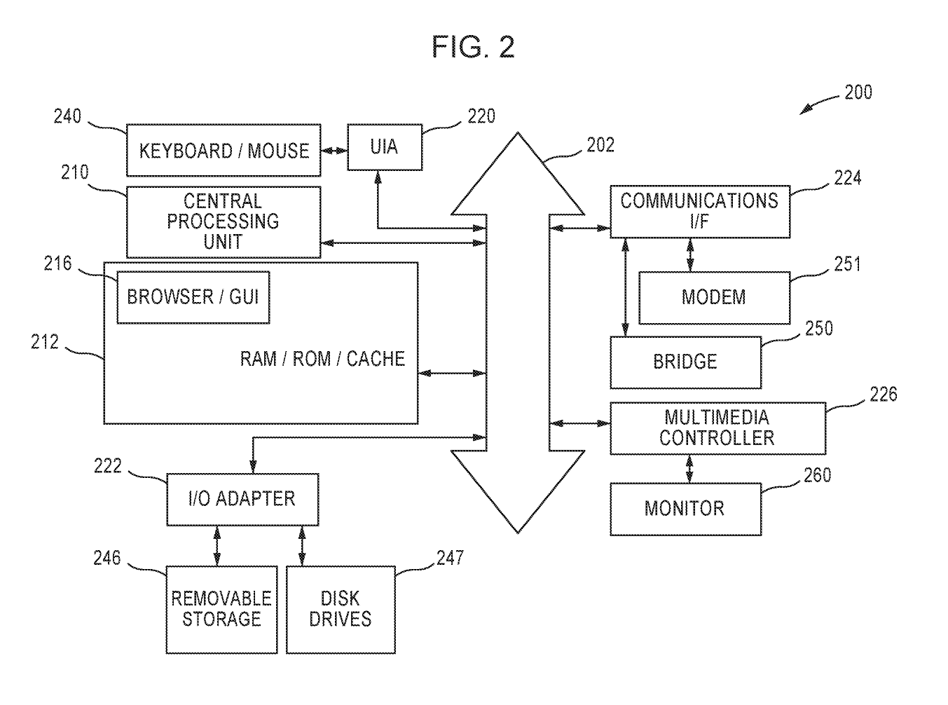

FIG. 2 depicts a block diagram of a processing device 200 utilized to provide the browser systems and methods disclosed herein. Processing device 200 may be analogous to client devices 102 and 104 and entity devices 150 and 152, disclosed above. Device 200 may execute an entire suite of computer programs to provide the functionality disclosed below to allow for the bidding and facilitation of delivery of content from an entity, such as a company, individual, and the like. Device 200 may be a computer that can access networks, but workstations, platforms, smart phones, tablets, smart televisions, or another other processing device would not depart from the scope of the disclosed embodiments.

Processing device 200 includes a processor 210. Processor 210 may be a conventional data processor, memory including random access memory (RAM), read only memory (ROM) and cache memory 212, and input/output adapter 222, a user interface adapter (UTA) 220, a communications interface adapter 224, and a multimedia controller 226. Processor 210 executes instructions to perform functions or processes. Thus, software instructions may configure processor 210 to perform a specific function to accomplish a specific goal. In other words, the disclosed embodiments configure processing device 200 into a specific machine to perform specific functions. These functions are disclosed in greater detail below.

Input/output (I/O) adapter 222 can be connected to, and control, disk drives 247, and removable storage devices 246. User interface adapter 220 can be considered to be a specialized I/O adapter. Adapter 220 may connected to a mouse and a keyboard 240. In addition, user interface adapter 220 may be connected to other devices capable of providing various types of user control, such as touch screen devices, track balls and pads, and the like. A microphone also may be used to receive verbal instructions to control processing device 200.

Communications interface adapter 224 can be connected to a bridge 250 for a local or wide area network, and a modem 251. Modem 251 may be internal or external. By connecting system bus 202 to various communication devices, external access to information on a network may be achieved. Multimedia controller 226 may include a video graphics controller capable of displaying images upon monitor 260, as well as providing audio to external components, such as speakers or headphones connected to processing device 200.

A graphical user interface (GUI) module 216 can be connected to a browser, such as browser 106, to control features and content provided on monitor 260. GUI 216 also may connect to system bus 202 to provide logic or instructions to facilitate a user-browser interaction associated with retrieval of websites and information. Central processing unit 210 can execute functions and provide useful interaction tools to a user during searches and selection of content over Internet 108, and during the submission of bids, updates, and commands to the advertisement-based platform. GUI 216 may interact with GUI module 117 of platform 112 to provide real-time information to a user.

In operation, a user operating device 200 can utilize GUI 216 to retrieve content from platform 112. Preferably, this content is exclusive content only available over platform 112. Archiver 214 stores the retrieved content locally, in RAM/ROM/cache memory 212 or on disk drive 247. This content may be made available to the user. Using GUI 216, the user may add content or modify existing content or access additional content over system 100.

After the content is received by device 200 via communications OF 224, and is displayed by monitor 260, a user may attempt modify the displayed contents utilizing browser 216. These modifications may be stored in memory 212. Upon completion, the modified content may be sent back to platform 112.

Using these configurations, a user may log into the disclosed system to access content that is not available to the public. Other users may provide compensation to the content providers using platform 112 that allows access to the content for a period of time or for a determined number of downloads/accesses. Further, some entities may bid on the right to underwrite the content delivery to the client devices.

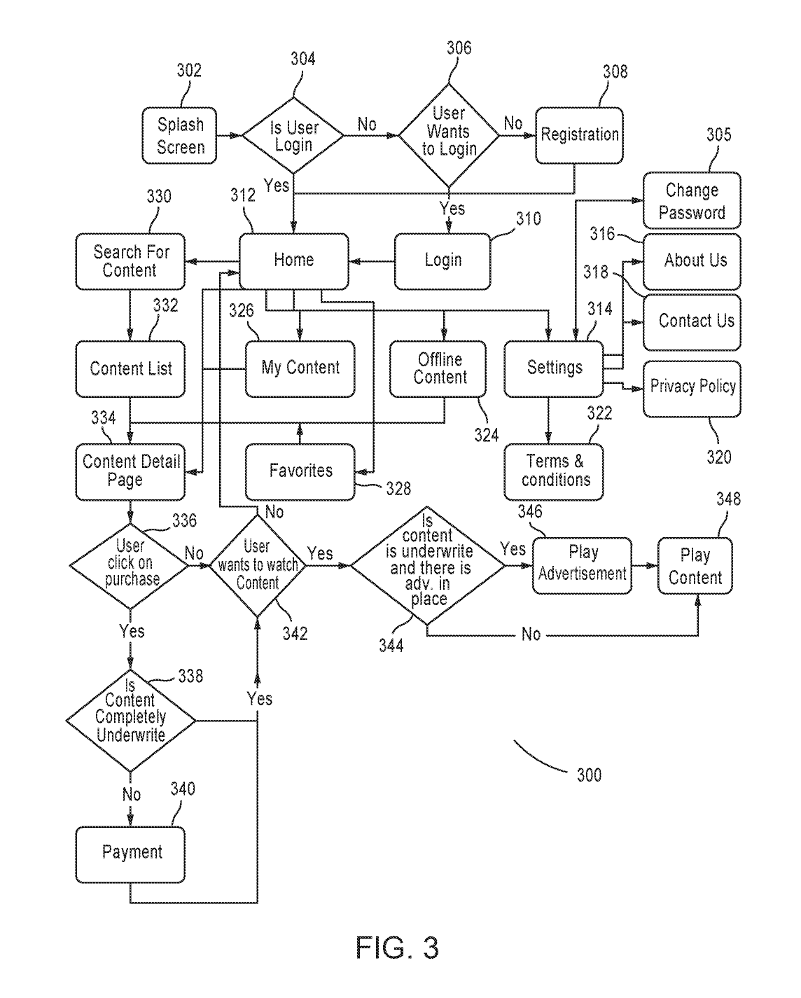

FIG. 3 depicts a flow diagram 300 for a process to provide content to a user according to the disclosed embodiments. In the following description, reference is made to client device 102 for illustrative purposes. The process configures client device 102 into a special purpose machine that operates in conjunction with platform 112 to provide content to the device.

Step 302 executes by providing a splash screen on the device. In some embodiments, client device 102 includes an application stored in memory 212 that is launched to convert processing device 200 (as client device 150) into a special purpose machine. The application launches and a splash screen is provided on the display in GUI 216 as the application loads into the cache memory.

Step 304 determines whether the user of client device 150 is logged in. If no, then step 306 executes by determining whether the user wants to log into the application. If the user selects no, or is unable to log in (such as with a new user), then step 308 executes by performing a registration process for the user. GUI 216 provides screens and input fields to allow the user to register with the application and to use platform 112 to access content within system 100. If step 306 is yes, step 310 executes by allowing the user to log into his/her account.

If step 304 is yes, and after completion of steps 308 and 310, then flow diagram 300 proceeds to step 312. Step 312 executes by placing the user at a home page or screen that provides menu features for selection. The user may select an action to perform from this screen by interacting with GUI 216. Inputs received are sent over network 110 to platform 112.

For example, the user may select to access settings in step 314. At the settings screen, the user may select an about us information page in step 316. Step 318 executes by providing information or an interface to allow the user to retrieve contact information. In some embodiments, a messaging platform may be enabled so that the user can communicate in real-time with support for platform 112. Step 320 executes by providing privacy policy information to the user. Step 322 executes by providing any terms and conditions placed upon the user for use of the application and platform 112 to obtain content.

The user may select to play content from the home page of step 312. Thus, step 324 executes by allowing the user to access offline content. This content may be stored at the device. The user may do the same using steps 326 and 328 to access his/her own content and favorite content, respectively. These steps then proceed to step 334, disclosed below.

The user also may search for content from the home page provided in step 312. Step 330 executes by searching for content available over platform 112 or within system 100. The user may use a screen supported by GUI 216 to search for the content. Step 332 executes by returning a content list to GUI 216.

Step 334 executes by providing a content detail page for selected content. The page may include information about the artist or content provider, format, and other information of interest. The content detail page may be compiled by platform 112 with information provided by server 126 or 124. Along with such information, the cost to access the content may be included as well as whether the content is available for download as part of a pending advertisement campaign.

Step 336 executes by determining whether the user clicks or selects the content for purchase. Under this process, the user is willing to provide compensation in order to access the content. If yes, then step 338 executes by determining whether the content is completely underwritten by an entity. Client device 102 asks platform 112 using manager 114 whether the user can access the content as part for an ongoing advertisement campaign. If yes, then flow diagram 300 proceeds to step 342. If no, then step 340 executes by receiving payment for accessing the content. Payment may be made through platform 112 that eventually is received by content provider 140 or 142. An administrator of platform 112 may also be compensated as a percentage or fee of the payment to the content provider.

If step 336 is no or step 338 is yes, then step 342 executes by determining whether the user wants to watch or access the content. Flow diagram 300 arrives at this step if the user does not want to purchase access to obtain the content or already purchased access in step 340. The user via GUI 216 indicates that he/she wants to access the content being provided through platform 112 and possibly underwritten by one or more entities. If no, then the user indicates that he/she is not interested in the content and flow diagram 300 returns to the home page of step 312.

If step 342 is yes, then step 344 executes by determining whether the content is underwritten by one or more entities and whether an advertisement is in place for viewing or hearing by the user. In other words, platform 112 allows the compensating entity to provide advertisement to the user in return for accessing the content. If yes, then step 346 executes by playing the advertisement for the entity. If no, then step 348 executes by playing or providing the content to the user. Thus, an entity underwriting the content delivery may not require that an advertisement be viewed before providing the content. Platform 112 may coordinate such activities as needed.

In some embodiments, step 340 may proceed directly to step 348 to play the content upon purchase of access through platform 112. A user may do this operation should he/she wish to avoid viewing the advertisement. Once the content has been viewed, then flow diagram 300 may return back to step 312 or proceed to ratings or feedback screens for the content. Additional information also may be obtained about the content provider at this point.

Using this process, the disclosed embodiments improve over conventional platforms that require a user to subscribe to access the content or be subject to annoying advertisements. An advertisement may be viewed as part of a campaign from an underwriter, but the consumer can avoid this feature be paying the transaction fee. Further, the consumer pays once and is not locked into continual payments or advertisements that last for months after viewing or listening to the content.

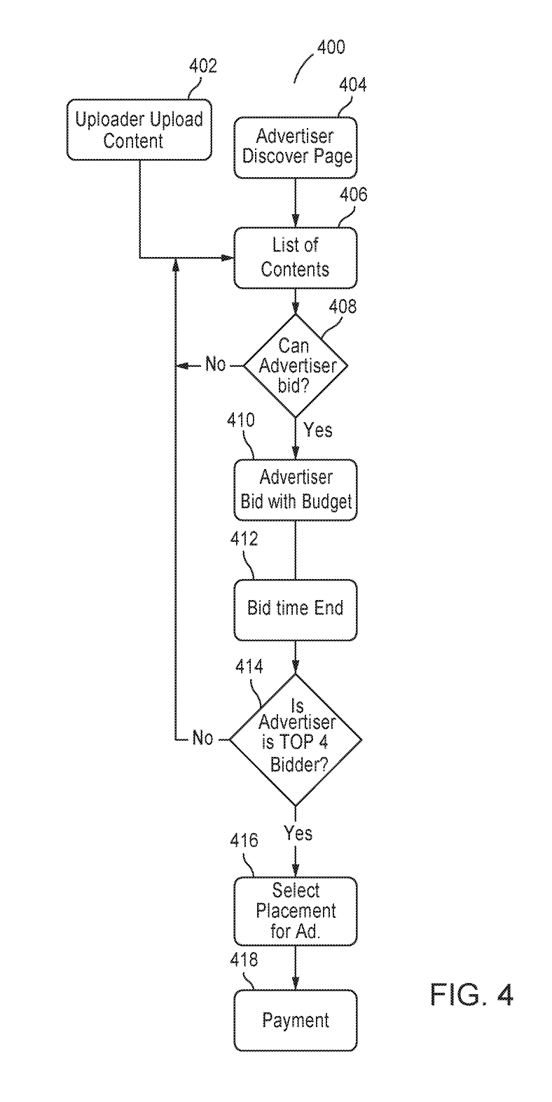

FIG. 4 depicts a flow diagram 400 of a process for purchasing and bidding for content access and advertisement using platform 112 according to the disclosed embodiments. As disclosed above, one or more entities may compensate the content providers for access to their content to provide it to users of the disclosed application. Entities may bid to be part of the content delivery event using an advertisement campaign.

Step 402 executes by content provider 140 (or any number of content providers) uploading content onto system 100. The content may be stored at server 126 or 128, and accessible via platform 112 using network 122. Step 404 executes by an entity, or advertiser, access a page promoting the campaign. An entity may use entity device 150 in doing so. The page is displayed. Referring back to FIG. 2, entity device 150 may resemble processing device 200 in that GUI 216 interacts with platform 112 and bidding resolution module 116.

Step 406 executes by providing a list of uploaded content that is available for bidding. In other words, the content providers will allow early access to their content in return for compensation. The advertiser selects content on which to bid. Step 408 executes by determining whether the advertiser is able to bid on the selected content. Some content providers may prohibit various groups or entities from underwriting their content. Government regulations also may prohibit sponsorship of certain content, such as a tobacco company purchasing access to content delivery of a children's movie. If no, then flow diagram returns back to step 406 for selection of alternative content.

If step 408 is yes, then step 410 executes by making sure a received bid from the advertiser is within any parameters set for the campaign. For example, the content provider or administrator of platform 112 may set a minimum bid to underwrite the content delivery. Other parameters may include type of currency, location of the advertiser/bidder, and the like. If the bid meets the criteria set forth, then the process receives bids from other entities. Step 412 executes by ending the bidding time. Bidding resolution module 116 may monitor and execute these processes. Bids may be received at module 116 and checked to ensure the bids meet the parameters.

Step 414 executes by determining whether the bid for a potential underwriter/advertiser is within the top X bids. Using the example shown, step 414 determines if the bid is within the top 4 kids. Bidding resolution module 116 ranks the bids and takes the top 4. Ranking may be done solely based on compensation or payment, or according to other criteria. If no, then the advertiser is directed back to step 406 to select other content.

If step 414 is yes, then step 416 executes by selecting placement for the advertisement in the content delivery process. Referring back to flow diagram 300, this may occur in step 346. The winning advertisers may provide their advertisements to platform 112. When delivering the content to client device 102, for example, the advertisement is provided as well. Step 418 executes by obtaining payment from the winner advertisers.

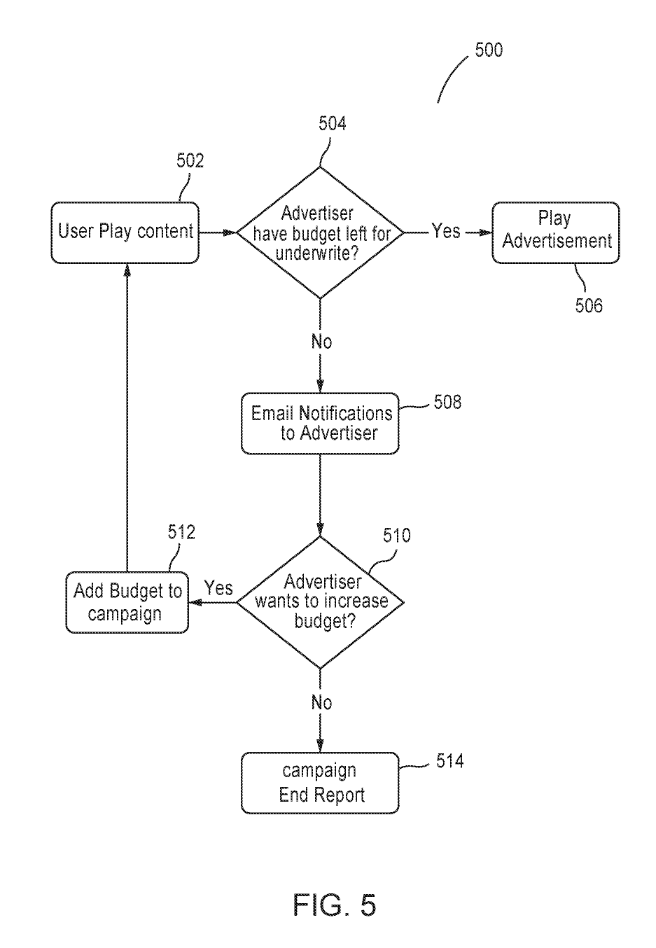

FIG. 5 depicts a flow diagram 500 for a process to further underwrite content delivery of an existing advertisement campaign according to the disclosed embodiments. An entity that is an advertiser may monitor a content delivery advertisement campaign to determine whether further involvement is warranted. If there is great interest from users in the content, then the advertiser may wish to further underwrite more downloads in order to have advertisement viewed by the users. Alternatively, if the campaign is not successful, then the advertiser may not wish to further engage.

Step 502 executes by user playing the content. This step corresponds to step 348 of flow diagram 300. The user plays the content that has been underwritten by a winning bidder selected in flow diagram 400. This action is noted at platform 112. Step 504 executes by determining whether the advertiser has enough budget left to underwrite additional downloads or accesses to the content. For example, the bid to underwrite may be for 100,000 downloads of the content. After this number is reached, users will need to purchase delivery of the content. If step 504 is yes, then step 506 executes by playing an advertisement for the winning advertiser.

If step 504 is no, then step 508 executes by notifying the advertiser through platform 112 that the budget is depleted. Methods of notification include emails, text message, or interacting with entity device 150, for example, using GUI module 117. GUI module 117 interacts with entity device 150 to provide real-time data to the advertiser whether to proceed with additional funds to underwrite the campaign. As the number of available downloads approaches zero, then the advertiser is notified.

Step 510 executes by determining whether the advertiser wants to increase their allotment of downloads by paying additional compensation into the campaign. Again, GUI module 117 provides real-time information to the advertiser on the campaign so that he/she/it can make a informed business decision on whether to proceed. Platform 112 aggregates the data across various components within system 100 to execute this process. If step 510 is yes, then step 512 executes by adding the additional funds or compensation to the budget for the campaign, which allows additional access to the content on behalf of the advertiser. Additional advertisements may be played in step 506 (or 346, if applicable). If step 510 is no, then step 514 executes by providing a campaign end report to the advertiser. Such a report may include information on registered users for follow up activities, such as email offers, direct mail circulations, and the like.

In addition, the content provider may receive information on the campaign, tailored to its particular needs. For example, the content provider may receive demographics related to the consumers downloading the content to determine its target audience. It also may receive real-time data as the campaign is occurring. As the campaign is in operation, the content provider may make available additional content aimed at the indicated audience. Unlike subscription services, which may take weeks or months to provide such data, platform 112 and the disclosed embodiments provide that information on demand.

When accessing the disclosed embodiments, one may be provided different screens through the application. For example, screens may include content detail screen for a potential user of platform 112, a content uploader screen/panel for a content provider, and an advertiser uploader screen/panel for underwriting content delivery to the public. These features are disclosed in greater detail below. Where applicable, the descriptions herein better define the concepts disclosed above with regards to FIGS. 1-5.

As noted above, a user of the disclosed embodiments may log into the service and access platform 112 using a login name and password. A user also may register using his/her name, email, and a password. In some instances, the email may serve as a user name. The user also may use the application a guest without logging in. A guest, however, may be limited to searching for content and may not have the capability to buy, play, view, or use content. If the user forgets his/her user name, email address, or password, then an email may be sent to appropriate email address with a temporary password. Other measures may be put into place to provide verification of the credentials of a user.

Once logged into the application, the user may land at a home page. Banners may be shown of featured or new content. Tabs or links may be provided that route the user to video, music, art, or product content. The home screen also may include quick access to content in the following categories: upcoming content, trending content, or popular content.

The user also may search for content using the content name, name of the content uploader or provider (i.e., a band, artist, producer, and the like), as well as keywords and search terms. The user also can filter content based on categories, genres, and the like as well as content uploaded recently. An example may be content uploaded in the last 48 hours.

Search results are returned to the user. The user clicks on a content thumbnail or icon to load a content detail screen for the selected content. The following information may be displayed for the particular content: content name, thumbnail or other graphic, content uploader details, description, and ratings. The user may purchase the content identified by the content detail screen. If the content is underwritten by an advertiser, as disclosed above, then the user can click on the appropriate link to watch or hear the content for free. The user also may download or purchase the content for free. Price for the content is based on what the content uploader determines and may differ depending on demand, volume, time available, and the like. The price may change daily, if applicable. If the content is underwritten, then the advertiser name along with a banner would be displayed at the bottom of the content detail screen. The user can share a link to the content with other applications using native share options. If the content is underwritten, then the applicable underwriter or underwriters would have an associated advertisement displayed based on the location identified in it winning bid BEFORE, DURING, or AFTER based on the content creator set up. The content creator is setting a bidding process for the content viewing.

As disclosed above, an advertiser may underwrite the whole content or a percentage of the content. The user may need to pay to receive the rest of the content not available through the underwriting process. “A percentage of the content” may indicate that an advertiser will underwrite up to a financial threshold that includes the successful bids. This option must match at least the minimum thresholds set forth by the content creator.

The user may pay for access to the content using in application purchases. The disclosed embodiments also include a third-party payment gateway for all payment options. The user also may redeem coupon codes or other discounts. Other payment plans may be implemented for individual users, such as purchasing credits that are applied to obtaining content. Coupon codes and other redeemable items may be created by an advertiser and provided to the user directly from the advertiser. For example, if the user registers with a loyalty customer program with the advertiser, then a coupon code is sent to the user to redeem on the disclosed platform to see exclusive content not available to the general public.

After purchase of the content, the user may play the video, listen to the music, or view the content, whichever is applicable. As disclosed above, underwritten videos may include advertisements played through the video player. Underwritten music may include audio advertisements played through a music player. Advertisements may be several seconds in length, but, preferably, not longer than the actual content. The user may seek ahead a number of seconds or back a number of seconds within the content using the applicable player. For example, one may seek in 10 second intervals. The advertisement cannot be bypassed using the seek function. Preferably, the video or audio format is compatible with every viewing platform. User also may have the option to download the content for offline viewing, but the content is playable only in the application.

The user also may engage with other functions while accessing the content. For example, the user may click on an advertisement to be redirected to a page for the advertiser. The user also can share content within the application using social media platforms. As noted above, the user may download the content but may be limited to only accessing the content in the application. The user's purchased content may be shown so that the user can easily access favorite or recent content.

The content uploader may refer to a content provider or another party licensed by the provider to upload content for access within the disclosed embodiments. The content uploader may log into the platform using email address and password. The registration process and capabilities may mirror those of the user disclosed above. One difference may be contact details for the content uploader. Further, the content uploader needs to provide bank details for use with the payment gateway.

A dashboard is provided so that one can see basic statistics of their content and upload new content. The disclosed embodiments allow the content uploader to provide new content for access over platform 112. The following details may be provided when adding content:

### Title,

### Category/genre,

### Thumbnail/avatar/graphic,

### Description,

Total allowed views,
Allowance for offline viewing,
Release date (actual release date when content would be available outside of the disclosed application),
Select pre-release date (date when content is available for access in the disclosed application),
Set price—uploader can set the price based on a periodic (daily, weekly, monthly, hourly) basis; uploader also can set the content to be free; price also may be set based on area, geographic location, and the like,
Underwriting allowed—the content uploader may allow underwriting. If underwriting is not allowed, then an advertiser cannot bid on the content,
Only allow exclusive underwriting—if the content uploader wants, then they can select this option and only allow underwriting by one advertiser; other restrictions may be placed on types of advertisers, such as mature product companies are not able to underwrite content meant for young children,
Allowed location for display of advertisements,
Bid start and end times,
Minimum amount for underwriting content (optional),
Minimum percentage of underwriting allowed for advertisers—an advertiser need to underwrite more than the minimum percentage, and
All revenue earned in connection with the campaign is subject to the applicable payment processor fees as fees for use of the disclosed platform.

In some embodiments, the uploader can change details of uploaded content, but may be limited to changing price. For example, the uploader may be locked into a single price for a day. The uploader may receive email notifications or information on the dashboard for new bid requests or notification from administrators. The content uploader also may view earning details or information.

Advertisers also may log onto platform 112 using an email address and password, as disclosed above. Unlike other entities, an advertiser needs to be approved before an account is established. A dashboard also is provided for the advertiser that includes all the content available for underwriting. Filters allow for content searching, such as by date, category/genre, or content type (music, video, and the like). Advertisers may be able to see all the details of the content as well as content provider profiles having previous content details.

An advertiser may enter a bid campaign to bid on underwriting content. The advertiser may add the following details:

Amount—must be greater than any minimum amount set by content uploader

### Dates,

Percentage of underwriting if the content uploader agrees to nonexclusive underwriting,
Upload of the advertisement—the advertisement must meet any parameters set forth by the content provider; advertisement should be simple and clear, and
Link to attach to the advertisement.

The advertiser also submits an advertisement placement request. Once bid time end, the advertiser can select which place the advertisements are going to display when the content is accessed. Placement requests may select before, after, or the middle of content. In the case of an exclusive underwriter, the advertiser also may select if only users with coupons will be able to access the content. Advertisers can distribute the coupons themselves. In some embodiments, first preference for selection would be given to the highest bidder. Payment also may be provided. The advertiser can add a budget to the campaign if desired. The advertiser also may use social media tools to promote the campaign and opportunity for users to obtain access to the content.

Once the campaign ends, the advertiser may view details about the campaign, such as total impressions, total clicks, and the like. The advertiser also may receive email notifications about advertisement placement requests, when less than a certain percentage is left in the budget, and once the campaign completes.

The disclosed embodiments may be supported and executed on a platform that has access to a network. The platform may support software and executable programs to provide the functionality disclosed above. For instance, the software may be deployed. Any software embodying the disclosed algorithm and its processes may be deployed by manually loading directly to the client, server and proxy computers via loading a storage medium such a CD, DVD, flash memory, chip, downloadable program and the like. The software also may be automatically or semi-automatically deployed into a computer system by sending the process software to a central server or a group of central servers. The software is downloaded into the client computers that execute the programs and instructions associated with the software.

Alternatively, the software may be sent directly to the client system via email. The software may be detached to a directory or loaded into a directory by a button on the email that executes a program that detaches the software into a directory. Another alternative is to send the software directly to a directory on the client computer hard drive. When there are proxy servers, the disclosed embodiments will select the proxy server code, determine on which computers to place the proxy servers' code, transmit the proxy server code, and install the proxy server code on the proxy computer. The software may be transmitted to the proxy server and then stored on the proxy server.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this specification, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more computer systems coupled to a network capable of exchanging information and data. These computer systems also may be general-purpose computer systems. Various functions and components of the computer system may be distributed across multiple client computer platforms, or configured to perform tasks as part of a distributed system. These components may be executable, intermediate or interpreted code that communicates over the network using a protocol. The components may have specified addresses or other designators to identify the components within the network.

According to the disclosed embodiments, a content provider may provide content directly to consumers on demand. Further, the content provider may be compensated directly for the content without the need for third party services or systems. A content delivery platform accepts payment and allows access to the content. In some embodiments, consumers pay to have access to the content before release on a non-payment platform.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A method for providing content to a consumer over a network, the method comprising:
receiving payment from the consumer or an entity at a content delivery platform;
identifying the payment for content created by a content provider;
accessing the content at a location within the network accessible by the content delivery platform; and
delivering the content to a device connected to the network.

2. The method of claim 1, further comprising providing information about the consumer to the content provider.

3. The method of claim 1, further comprising receiving payment for the content from an entity.

4. The method of claim 1, further comprising denying access to the content after it is viewed.

5. The method of claim 1, wherein the identifying the payment includes identifying a coupon for the content.

6. The method of claim 1, wherein the identifying the payment includes determining that the payment is not from the consumer.

7. The method of claim 1, further comprising delivering an advertisement along with the content.

8. A method for delivering content to a plurality of consumers over a network, the method comprising:
receiving payment for delivery of the content over the network at a content delivery platform, wherein the payment is provided by an entity;
providing the content from a content provider to the plurality of consumers over the network using the content delivery platform;
tracking in real-time the amount of payment left after at least one delivery of the content;
determining when the payment is depleted or a limit for delivery of the content has been reached; and
stopping delivery of the content over the network using the content delivery platform.

9. The method of claim 8, further comprising receiving additional payment for continued delivery of the content over the network.

10. The method of claim 8, further comprising providing an advertisement from the entity along with the content.

11. The method of claim 8, further comprising providing real-time information regarding the plurality of consumers during delivery of the content.

12. The method of claim 8, wherein the receiving payment includes a percentage of an overall cost to deliver the content.

13. The method of claim 12, wherein the percentage is greater than a set percentage in order to deliver the content.

14. A method for bidding to provide content over a network to a plurality of consumers, the method comprising:
indicating content to be made available over the network through a content delivery platform;
receiving at least one bid to make the content available over the network via payment to a content provider of the content;
determining one or more bids to accept payment from at least one entity to provide the content at the content delivery platform; and
delivering the content to the plurality of consumers according the payment or payments received corresponding to the one or more bids.

15. The method of claim 14, further comprising determining that the at least one bid meets a minimum bid.

16. The method of claim 14, further comprising receiving the payment or payments as coupons provided by the at least one entity.

17. The method of claim 14, further comprising receiving an additional bid to continue delivering the content.

18. The method of claim 14, further comprising delivering an advertisement from the at least one entity along with the content to the plurality of consumers.
